(19) United States
(12) Patent Application Publication
(10) Pub. No.: US 2023/0012185 A1
(43) Pub. Date: Jan. 12, 2023

(54) Cable organizer

(71) Applicant: Ning MENG, Guangdong (CN)

(72) Inventor: Ning MENG, Guangdong (CN)

(21) Appl. No.: 17/367,644

(22) Filed: Jul. 6, 2021

(51) Int. Cl. F16L 3/223

(52) U.S. Cl. CPC F16L 3/223

(57) ABSTRACT

This invention provides a cable organizer including an elongated board for cable winding; a plurality of storage slots are opened on the elongated board; the storage slots are arranged along a longitudinal direction of the elongated board. To use the cable organizer of this invention, the adapter of the power cable and the elongated board are stacked together with the storage slots exposed, then the cable is winded around the adapter and the elongated board, and the sections of the cable at the elongated board are snapped into the storage slots, thereby storing the power cable securely and tightly.

### BACKGROUND OF THE INVENTION

The present invention relates to a cable organizer.

The power cable of a notebook computer comprises a cable for transmitting power and an adapter for adjusting current. It is a notebook computer accessory. The power cable is required for supplying power to the notebook computer, but in the prior art, when the computer is not in use, the power cable is usually not well-stored, causing storage inconvenience.

### BRIEF SUMMARY OF THE INVENTION

In view of the aforementioned technical problems, the present invention provides a cable organizer comprising an elongated board for cable winding; a plurality of storage slots are opened on the elongated board; the storage slots are arranged along a longitudinal direction of the elongated board.

Furthermore, anti-disengagement protrusions are disposed on two sides of opening of each of the storage slots.

Furthermore, each of the anti-disengagement protrusions is spherical arc-shaped.

The present invention has the following beneficial effects:

To use the cable organizer of this invention, the adapter of the power cable and the elongated board are stacked together with the storage slots exposed, then the cable is winded around the adapter and the elongated board, and the sections of the cable at the elongated board are snapped into the storage slots, thereby storing the power cable securely and tightly.

### BRIEF DESCRIPTION OF THE DRAWINGS

FIG. 1 is a schematic view of the cable organizer of the present invention.

FIG. 2 is another schematic view of the cable organizer of the present invention.

FIG. 3 is a schematic view showing use of the cable organizer of the present invention.

### DETAILED DESCRIPTION OF THE INVENTION

The present invention is clearly and comprehensively explained herein with reference to the accompanying drawings in the embodiment of the present invention. Obviously, the embodiment that is described herein is only one of the possible embodiments of the present invention but not the only embodiment of the present invention. All other embodiments obtainable without any inventive effort by a person skilled in this field of art based on the embodiment of the present invention disclosed herein should also fall within the scope of protection of the present invention.

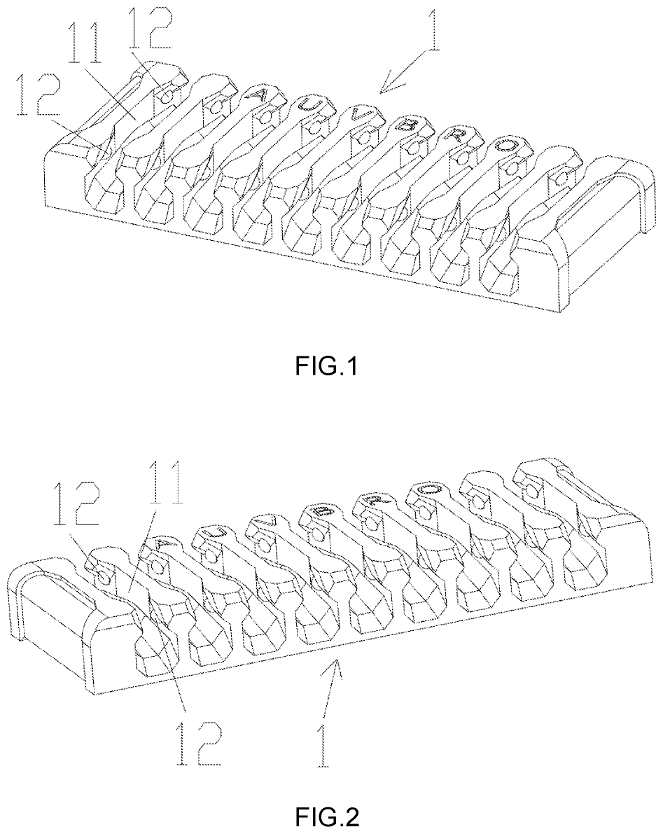

As shown in FIGS. 1 to 2, the cable organizer of the present invention comprises an elongated board 1 for cable winding. A plurality of storage slots 11 are opened on the elongated board 1. The storage slots 11 are arranged along a longitudinal direction of the elongated board 1.

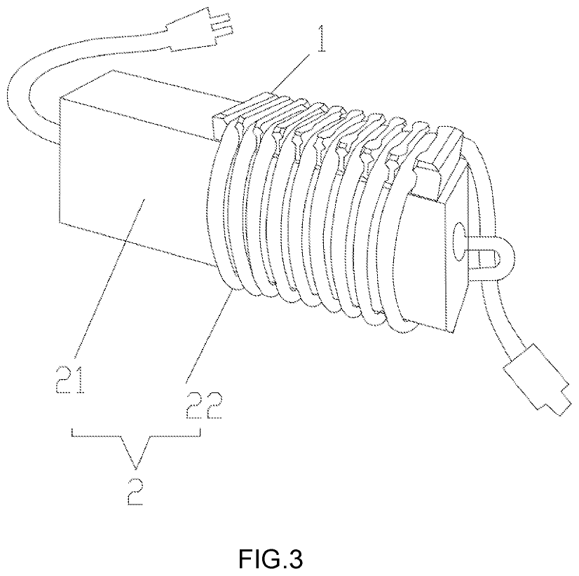

To use the cable organizer of the present invention, the adapter 21 of the power cable 2 and the elongated board 1 are stacked together with the storage slots 11 exposed, then the cable 22 is winded around the adapter 21 and the elongated board 1, and the sections of the cable 22 at the elongated board 11 are snapped into the storage slots 11, thereby storing the power cable 2 securely and tightly, as shown in FIG. 3.

Furthermore, anti-disengagement protrusions 12 are disposed on two sides of opening of each of the storage slots 11. When the sections of the cable 22 are snapped into the storage slots 11, the anti-disengagement protrusions 12 limits disengagement of the cable 22.

Furthermore, each of the anti-disengagement protrusions 12 is spherical arc-shaped. By configuring the anti-disengagement protrusions 12 as spherical arc-shaped, the sections of the cable are prevented from being stuck in the storage slots 11 when the sections of the cable are snapped into or removed from the storage slots by external force.

While the embodiment of the present invention has been described and illustrated to the fullest extent, the persons skilled in the art may make any changes, modifications, alternations and variations without departing from the principle and spirit of the present invention. The scope of the present invention is defined by the accompanying claims and equivalents thereof.

What is claimed is:

1. A cable organizer comprising an elongated board for cable winding; a plurality of storage slots are opened on the elongated board; the storage slots are arranged along a longitudinal direction of the elongated board.

2. The cable organizer as in claim 1, wherein anti-disengagement protrusions are disposed on two sides of opening of each of the storage slots.

3. The cable organizer as in claim 2, wherein each of the anti-disengagement protrusions is spherical arc-shaped.
